(19) United States
(12) Patent Application Publication
(10) Pub. No.: US 2010/0156792 A1
(43) Pub. Date: Jun. 24, 2010

(54) MOUSE

(76) Inventors: Chung-Chuan Chou, Bade City (TW); Chun-Chung Huang, Taipei City (TW)

Correspondence Address: PATTERSON & SHERIDAN, LLP - - - IPTEC, 3040 Post Oak Boulevard, Suite 1500, Houston, TX, 77056-6582, US

(21) Appl. No.: 12/643,476

(22) Filed: Dec. 21, 2009

(30) Foreign Application Priority Data
Dec. 23, 2008 (TW) 097223082

(51) Int. Cl. G06F 3/033

(52) U.S. Cl. 345/163

(57) ABSTRACT

A mouse is disclosed and includes a wheel assembly which includes a first wheel and a second wheel. The second wheel is disposed adjacent to the first wheel. There is a predetermined distance between the first wheel and the second wheel. Particularly, a user can selectively roll the first wheel, roll the second wheel, or both of roll the first wheel and the second wheel at a time by only one finger.

### BACKGROUND OF THE INVENTION

1. Field of the Invention

This invention relates to a mouse and more particularly, relates to a mouse whose wheel could be rolled easily by single finger so as to perform various computer functions.

2. Description of the Prior Art

As for habits of using personal computers, the mouse is one of indispensable input devices. People name it “MOUNSE” for that it could be dexterous like a real mouse so as to replace our fingers to perform the clicking required for operating a computer. In addition, from the first generation of mechanical mouse, the movement sensing module of the mouse has been developed through several development stages of photo-mechanics stage, photo-electricity stage, etc. Even the mouse could transmit signals to a computer by use of a wireless transmission module.

A normal mechanical mouse calculates the direction and distance of movement of a cursor on a screen according to the movement of a ball inside a disk encoder. An optical mouse determines the distance of movement of the mouse according to the receiving of images in a period of time by radiating red light from LED onto a flat surface. In other words, the moving method for a cursor adopted by the conventional mouse is to move the mouse along the direction corresponding to the cursor, and achieve the purpose of controlling the cursor on the detection by the movement sensing module.

In the meantime, the mouse develops continuously toward precise positioning, customized appearance, etc. It tends to make the mouse, a minor role originally, become the major of desktop devices. It also represents the time for using mousse longer. Most of the mice in the present market have the functions of controlling cursor and clicking; the designs thereof focus almost on appearance.

However, the mice in the present market are designed as a whole at the design stage before the manufacturing stage. Most of them only provide single function of controlling cursor. Recently, Internet develops rapidly and amazingly. People almost hang on web pages everyday. Therefore, people pay more attention to how to improve the convenience for browsing web pages.

Therefore, the manufacturers producing mouse recently manufacture mice with a wheel at the front thereof for a user to more easily browse web pages. The wheel could roll forwards or backwards by use of a finger to drive the webpage scrolls up or down. So far, the wheel providing only two functions cannot satisfy users' request. The wheel has been asked to provide more functions, so not only the practice and convenience but also the added value of the wheel increases.

### SUMMARY OF THE INVENTION

The invention discloses a mouse which includes a wheel assembly which includes a first wheel and a second wheel. The second wheel is disposed adjacent to the first wheel. There is predetermined distance between the first wheel and the second wheel. A partition plate pivotally connected to the first wheel and the second wheel could be disposed in the predetermined distance. The partition plate is used for avoiding friction between the first wheel and the second wheel. Therein, a user can selectively roll the first wheel, the second wheel, or both of the first wheel and the second wheel at a time.

Furthermore, the first wheel includes a first recess formed at a side of the first wheel opposite to the second wheel, and a profile of the first recess is suitable to a finger of the user for rolling. The second wheel also includes a second recess formed at a side of the second wheel opposite to the first wheel, and a profile of the second recess is suitable to a finger of the user for rolling.

The mouse of the invention further includes a first encoder and a second encoder. The first encoder is pivotally connected to the first wheel. The second encoder is pivotally connected to the second wheel.

Compared with the prior art, the mouse of the invention could be easy to selectively roll the first wheel or the second wheel, which are disposed very closely, even or both of the first wheel and the second wheel at a time by only a finger. The mouse of the invention could work cooperatively with the encoders so as to perform the output operations of various computer functions by the same finger.

The advantage and spirit of the invention may be understood by the following recitations together with the appended drawings.

### BRIEF DESCRIPTION OF THE APPENDED DRAWINGS

FIG. 1 is a schematic diagram illustrating a mouse according to an embodiment of the invention.

FIG. 2A is a schematic diagram illustrating the associated components with the wheel assembly of the mouse in FIG. 1.

FIG. 2B is a schematic diagram illustrating the connection of the partition plate different to FIG. 2A.

FIG. 3 is a schematic diagram illustrating the output of the encoded signals from the mouse.

### DETAILED DESCRIPTION OF THE INVENTION

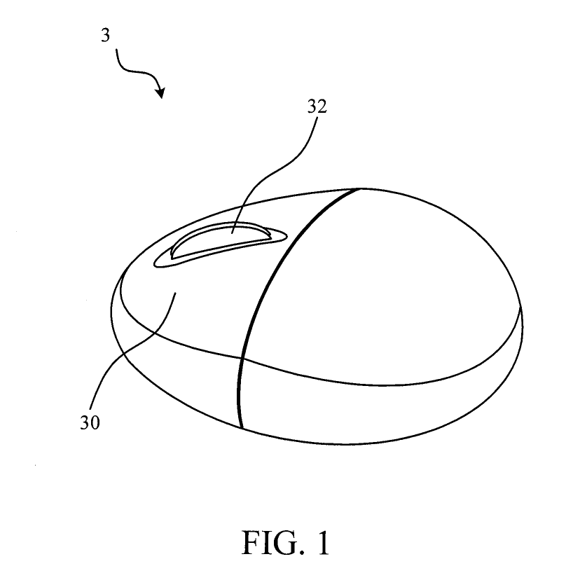

Please refer to FIG. 1. FIG. 1 is a schematic diagram illustrating a mouse 3 according to an embodiment of the invention. As shown in FIG. 1, the mouse 3 includes a casing 30 and a wheel assembly 32. The wheel assembly 32 is disposed on and partially protrusive from the casing 30. It is noticed that the wheel assembly 32 is not limited to be disposed at the position shown in FIG. 1 but could be disposed at any position on the casing 30.

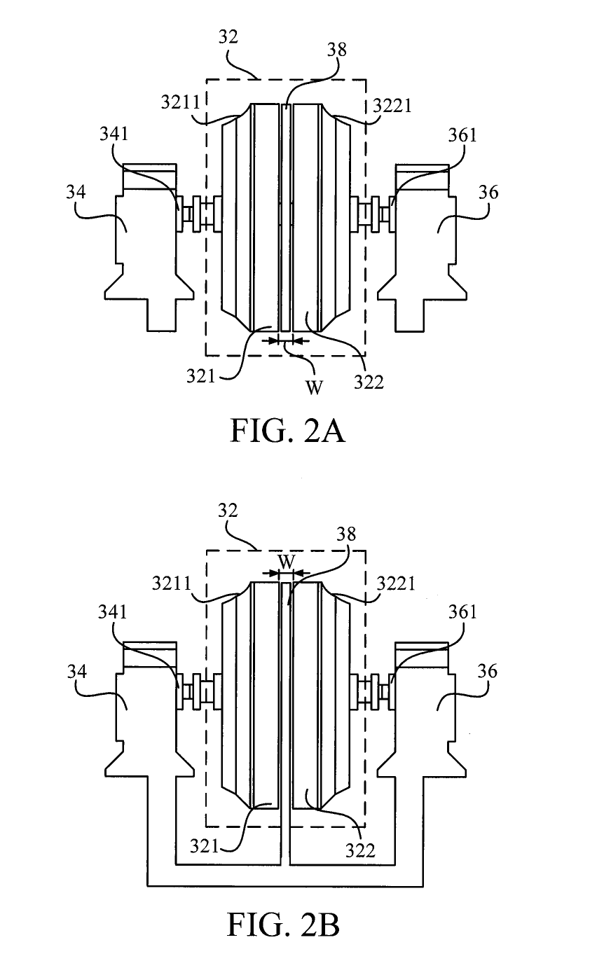

Please refer to FIGS. 1 and 2A. FIG. 2A is a schematic diagram illustrating the associated components with the wheel assembly 32 of the mouse 3 in FIG. 1. As shown in FIG. 2A, the associated components with the wheel assembly 32 of the mouse includes a first wheel 321, a second wheel 322, a first supporting structure 34, and a second supporting structure 36.

As shown in FIG. 2A, the first wheel 321 is disposed adjacent to the second wheel 322. There is a predetermined distance W between the first wheel 321 and the second wheel 322. In this embodiment, the predetermined distance W is 0.1 cm to 1 cm. It is noticed that the predetermined distance W could be adjusted according to different conditions, not limited to the above range.

Furthermore, the mouse 3 further includes a partition plate 38 disposed between the first wheel 321 and the second 322 in the predetermined distance W. The partition plate 38 is pivotally connected to the first wheel 321 and the second wheel 322 respectively. The purpose of disposing the partition plate 38 is mainly to avoid the friction between the first wheel 321 and the second wheel 322.

In particular, please refer to FIG. 2B. FIG. 2B is a schematic diagram illustrating the connection of the partition plate 38 different to FIG. 2A. As shown in FIG. 2B, the partition plate 38 could be made in one piece together with the first supporting structure 34 and the second supporting structure 36. It makes the first wheel 321 and the second wheel 322 independent and reduces the risk of one wheel being driven to move as the other wheel rolls.

As also shown in FIG. 2A, the first supporting structure 34 is operatively connected to the first wheel 321 for supporting the first wheel 321 when the first wheel 321 rolls. The second supporting structure 36 is operatively connected to the second wheel 322 for supporting the second wheel 322 when the second wheel 322 rolls.

The mouse 3 of the invention further includes a first encoder 341 and a second encoder 361. The first encoder 341 is disposed on the first supporting structure 34 and pivotally connected to the first wheel 321. The second encoder 361 is disposed on the second supporting structure 36 and pivotally connected to the second wheel 322. Therein, the first encoder 341 and the second encoder 361 are mechanical encoders, but not limited to this.

By the disposition of the components of the mouse 3, a user could only use single finger selectively roll the first wheel 321, the second wheel 322, or both of the first wheel 321 and the second wheel 322 at a time. In addition, the first wheel 321 comprises a first recess 3211 formed at the side of the first wheel 321 opposite to the second wheel 322, and the profile of the first recess 3211 is suitable to the finger of the user for rolling. The second wheel 322 comprises a second recess 3221 formed at the side of the second wheel 322 opposite to the first wheel 321, and the profile of the second recess 3221 is suitable to the finger of the user for rolling. In practical application, the user could roll the wheels easier and more convenient by the design of the first recess 3211 and the second recess 3221 for aiding the rolling.

The following will describe the functions of the mouse of the invention in detailed.

TABLE 1

| | forward | backward | press |
|---|---|---|---|
| first wheel | A | B | C |
| second wheel | D | E | F |

TABLE 2

| encoded signal | executed operation |
|---|---|
| A | scroll up |
| B | scroll down |
| C | display desktop |
| D | close web page |
| E | add web page |
| F | print web page |
| AD | back to the previous |
| BE | back to the next |
| CF | back to home page |

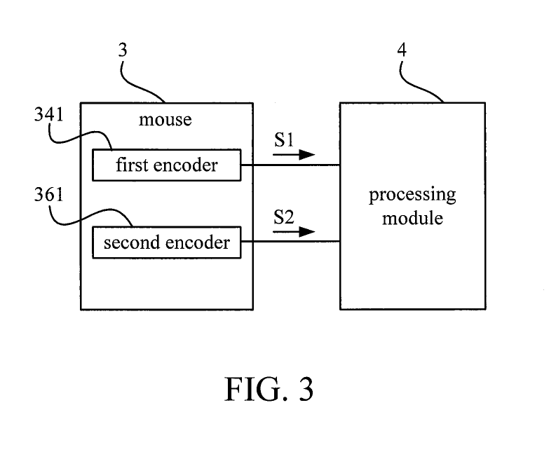

Please refer to FIG. 3 and the tables 1 and 2. FIG. 3 is a schematic diagram illustrating the output of the encoded signals S1 and S2 from the mouse 3. The table 1 is the table of the operations of the wheel assembly 32 to the output encoded signals. As shown in the table 1, A through F in the table 1 defines the encoded signals corresponding to the great bulk of mechanical operations of the wheel assembly 32. In particular, the encoded signals could be within a voltage or current range. For the convenience of explaining in the following, the letters of A through F in the table 1 are used to represent the encoded signals of the operations of the wheel assembly 32.

The table 2 is the table of the functions corresponding to the encoded signals in the table 1. In particular, the functions in the table 2 corresponding to the encoded signals could be customized by user or predetermined by manufacture. As shown in FIG. 3, the first encoder 341 and the second encoder 361 of the mouse 3 are electrically connected to a processing module 4. A first signal S1 outputted by the first encoder 341 of the mouse 3 and a second signal S2 outputted by the second encoder 361 of the mouse 3 are inputted to the processing module 4. Furthermore, the processing module 4 could store a function table similar to the table 2 in advance.

For example, if the first wheel 321 rolls forward by a forefinger, the first encoder 341 determines the operation of rolling forward by the user. After looking up the table 1, it is known that the message symbol of the rolling forward is the message A and the first encoder 341 therefore encodes the operation into the first signal S1 containing the message A. Then, the first signal S1 is inputted to the processing module 4. The processing module 4 receives the first signal S1 and analyzes the first signal S1 to find out the message A contained in the first signal S1. After looking up the table 2, the executed operation corresponding to the message A is scrolling up. Therefore, the processing module 4 executes the operation of scrolling up.

For example further, both of the first wheel 321 and the second wheel 322 roll forward at a time by the forefinger. The first encoder 341 then outputs the first signal S1 containing the message A to the processing module 4; the second 361 then outputs the second signal S2 containing the message D to the processing module 4. The processing module 4 receives the first signal S1 containing the message A from the first encoder 341 and the second signal S2 containing the message D from the second encoder 361. After receiving the signals, the processing module 4 processes the signals and looks up the table 2 to find out the executed operation is back to the previous. Therefore, the processing module 4 executes the operation of back to the previous. In particular, the finger for rolling the wheel assembly 32 could be determined according to where the wheel assembly 32 is disposed. It is not limited to the forefinger in the embodiment.

Compared with the prior art, the wheel assembly of the mouse of the invention could make the user easily use only single finger to perform at least nine output operations of different functions. Besides, the recess whose profile matches with the shape of the finger is formed at side of the wheel, so that the user could be roll the wheel of the mouse more easily and it not only improves the practice and convenience of the wheel of the mouse but also increases the added value of the mouse.

With the example and explanations above, the features and spirits of the invention will be hopefully well described. Those skilled in the art will readily observe that numerous modifications and alterations of the device may be made while retaining the features and spirit of the invention. Accordingly, the above disclosure should be construed as limited only by the metes and bounds of the appended claims.

What is claimed is:

1. A mouse, comprising:
a wheel assembly, comprising:
a first wheel; and
a second wheel, disposed adjacent to the first wheel, and there is a predetermined distance between the first wheel and the second wheel;
wherein a user can selectively roll the first wheel, the second wheel, or both of the first wheel and the second wheel at a time.

2. The mouse of claim 1, wherein the predetermined distance is 0.1 cm to 1 cm.

3. The mouse of claim 1, wherein the first wheel comprises a first recess formed at a side of the first wheel opposite to the second wheel, and a profile of the first recess is suitable to a finger of the user for rolling.

4. The mouse of claim 1, wherein the second wheel comprises a second recess formed at a side of the second wheel opposite to the first wheel, and a profile of the second recess is suitable to a finger of the user for rolling.

5. The mouse of claim 1, further comprising a partition plate disposed between the first wheel and the second wheel for avoiding friction between the first wheel and the second wheel.

6. The mouse of claim 5, wherein the partition plate is pivotally connected to the first wheel and the second wheel respectively.

7. The mouse of claim 1, further comprising:
a first encoder, pivotally connected to the first wheel; and
a second encoder, pivotally connected to the second wheel.

8. The mouse of claim 7, wherein the first encoder and the second encoder are mechanical encoders.
